(19) United States
(12) Patent Application Publication
(10) Pub. No.: US 2004/0065377 A1
(43) Pub. Date: Apr. 8, 2004

(54) Wear indicator and detector for hoses

(75) Inventor: Eric Ronald Whiteley, Collaroy Plateau (AU)

Correspondence Address: RHEOX, INC., WYCKOFFS MILL ROAD, P O BOX 700, HIGHTSTOWN, NJ, 08520

(73) Assignee: Linatex Australia Pty.

(21) Appl. No.: 10/265,234

(22) Filed: Oct. 7, 2002

(51) Int. Cl. F16L 55/00

(52) U.S. Cl. 138/104

(57) ABSTRACT

A monitoring system to detect hose failure is described in a system for hoses or pipes used in mining operations to transfer ore and similar materials. Such system in combination includes:

a) a hose with means within the hose or pipe wall for providing an electrically conductive path, the conductive characteristics of said path being related to the integrity of said hose or pipe wall;

b) detection means for detecting a change in the conductive characteristics of said conductive path so as to indicate a change in the integrity of said hose wall; and

c) communication means coupled to said detection means for providing a signal representative of the change in conductive characteristic and preferably the location of the detection device detecting such change.

A plurality of means for providing an electrically conductive paths, detection devices and associated communication means are preferably provided along the length of a hose or pipe.

The signal is transmitted by radio to a receiver housed in a central monitoring station where it can be monitored to detect hose potential failure before the hose actually ruptures or breaks.

### BACKGROUND OF THE INVENTION

1. Field of the Invention

The present invention relates to an indicator and detector for monitoring wear of hoses, in particular, hoses carrying substances of an aggressive nature such as ore and coal being transported in mining operations.

2. Background

This application relates to Australian Published Patent Application No. 31549/01.

Mining or dredging hoses and pipes are used, for example, to transfer crushed ore, sand and other material from mining sites or dredged areas to treatment plants. Such hoses and pipes are usually made in part of rubber. Because of the aggressive nature of ore, inner hose lining, which is normally manufactured from natural rubber compounds, suffers a high degree of wear. If there is a curve or bend in the hose or pipe, or any intrusion that could cause turbulence, the hose often wears prematurely in one part of the length and can unless monitored, break, and then release large quantities of water and ore unexpectedly into the environment.

At present, most hoses used are normally completely worn through before the wear is detected. This can cause leakage of material, which is not only a danger to personnel due to the high pressure of the material in the hose or pipe, but also the spillage can be an environmental hazard, as well as the obvious loss in production.

It is therefore a distinct advantage for the hose/mining operator to be pre-warned of such a situation and therefore it is desirable to detect such wear locations and pre-warn the operator to prevent wearing the hose completely through. It is normal practice for the operator to estimate the life expectancy of the hose and to change out and replace it with a new hose before it becomes a critical situation.

The disadvantage of this however, is that many hoses are removed and replaced even though they may have considerably more lining material left in the hose before it becomes a danger or a critical situation.

There have been a few attempts to solve the problem discussed above. Prior art to give a general background of the invention includes:

U.S. Pat. No. 4,112,417 shows an apparatus for detecting leakage in a wall of piping used to transport liquid sodium.

U.S. Pat. No. 4,446,892 shows a fluid transport hose using a sensor element responsive to the electromagnetic properties of a fluid; alternatively the sensing element may be adapted to respond to the failure of an inner ply of the hose by presenting an open circuit.

U.S. Pat. No. 4,617,822 indicates awareness of the special problems caused by the transport of highly abrasive materials such as coal, coke, ore, ash, sand and grain through pipeline systems and the critical risks of breakdown of a small portion of the pipe. The difficulty involved in predicting such failure is detailed in some length.

U.S. Pat. No. 4,449,098 describes an arrangement for detecting the location of an electrically insulative continuous item positioned underground.

U.S. Pat. No. 5,634,497 describes using a hose manufactured in accordance with known techniques for slurries containing abrasive material with a sensor triggered by means of a connection with two layers of braided copper wire for indicating total or partial wear of the internal layer of the hose.

WO Patent No. WO 00/70326 describes an erosion detector using a conductor which is monitored electrically. A continuity test indicates when the lining involved has worn to the depth to which the conductor is imbedded within the lining used.

Recent U.S. Pat. No. 6,070,617 describes a liquid transferring hose provided with an internal rubber layer and a cover rubber layer for delivery liquids such as oils. A transponder which transmits and receives waves of specific frequency changes its transmission characteristics on contacting liquid. The transponder is installed between the two different rubber layers.

Most recent U.S. Pat. No. 6,386,237 describes a abrasive material transport hose which can be repositioned at the first sign of internal wear using at least two wear sensing elements each at a specified distance from the inwardmost surface of the inner tube of the hose.

It is an object of the present invention to overcome or at least ameliorate one or more of the disadvantages of the prior art or at least provide the public with a useful alternative.

### BRIEF DESCRIPTION OF THE DRAWINGS

A preferred embodiment of the present invention will now be described, by way of example only, with reference to accompanying drawings, in which:

FIG. 1 shows a side elevation view of a typical hose arrangement illustrating the location of a detector/transmitter device according to the invention;

FIG. 2 shows a perspective view of the housing and external componentry of a representative detector/transmitter device of FIG. 1;

FIG. 3 shows a very summary pictorial view of a representative receiver device employed in the embodiment of FIG. 1;

FIG. 4 shows a schematic block circuit diagram of the transmitter system according an embodiment of the invention; and

FIG. 5 shows a representative schematic block circuit diagram of the receiver system according an embodiment of the invention.

### THE INVENTION AS ILLUSTRATED BY THE DRAWINGS

The description and the following discussion of the drawings are set forth merely to illustrate the invention and are not intended to be limiting. Since modifications of the disclosed embodiments in the drawings and in the description hereof incorporating the spirit and substance of the invention may easily occur to persons skilled in the art, the invention should be construed broadly to include all variations falling within the scope of the claims detailed below and equivalents thereof

Referring to FIG. 1 of the drawings, the dredge or mining hoses 5 are often constructed in lengths 6 of approximately 20 meters and are joined together with a metal coupling 7 which allows the hose 5 to be coupled in series to extend its length, depending on the site and usage of the hose.

This embodiment of the invention incorporates a flexible electrically conductive wire 8, typically copper, that is embedded in a spiral or helix in the hose wall or inner tube of the mining or dredge hose 5 during the manufacture of the hose. The wire 8 can be inserted at a predescribed depth in the hose wall, generally allowing sufficient rubber below the wire so that there is a safety margin between the time the alarm is activated by the breaking of the wire and the hose reaching a point where the hose would burst and discharge the material.

The aggressive nature of material that is being carried through the hose causes the wall or lining to wear rapidly though not evenly and therefore the detector wire 8 being spirally wound around the hose diameter, covers, if possible, the full extent of the hose lining so that irrespective of where the hose wear takes place it will wear through the detector wire 8 and signal an alarm through the transmitter unit 10.

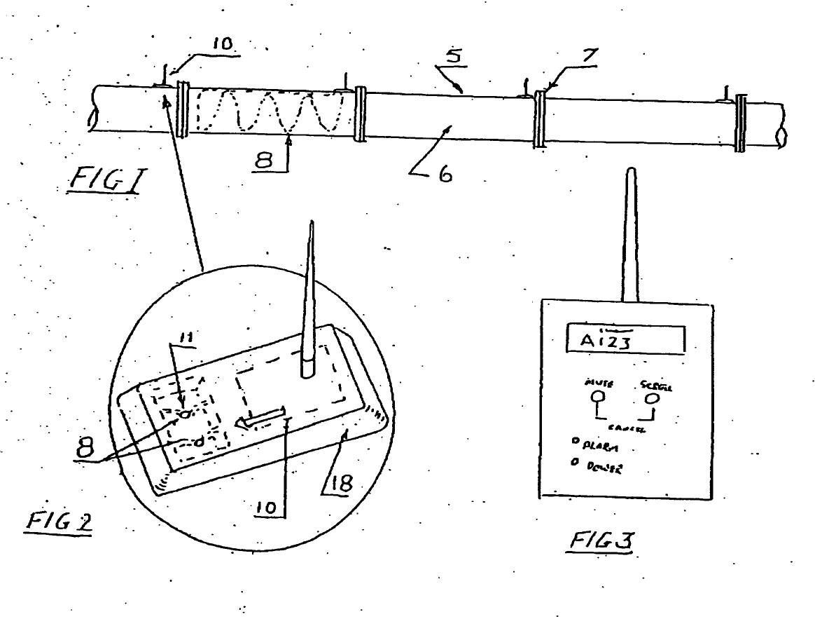

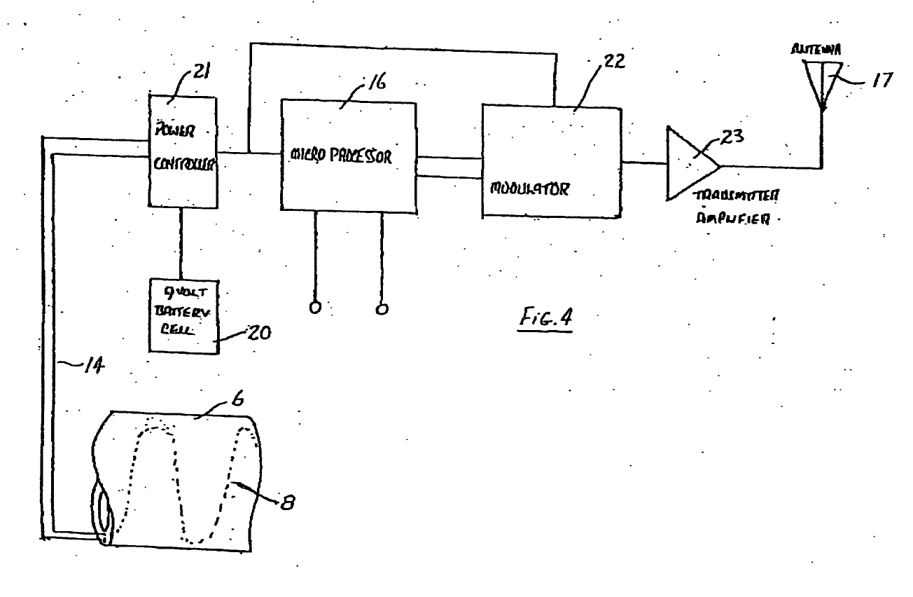

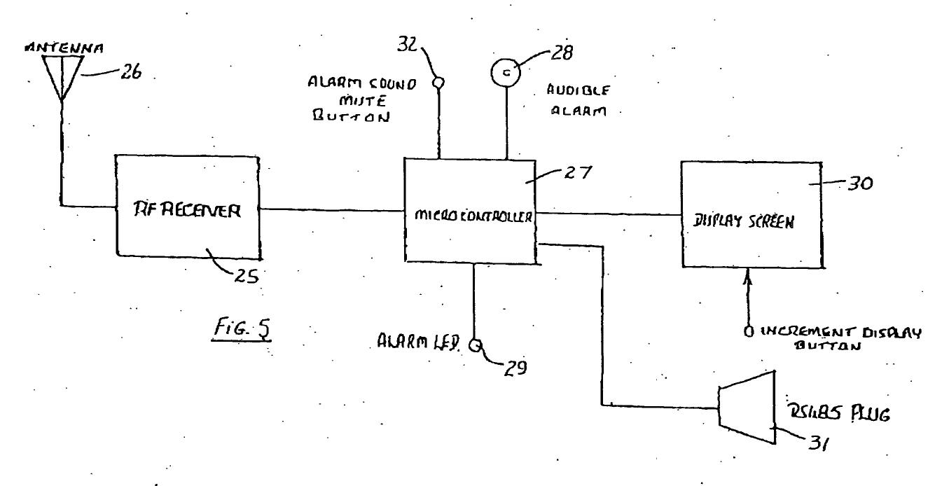

FIG. 2 shows an external view of the detector/transmitter device 10 having connector 11 for coupling to detector leads 8. An input plug 15 is optionally also provided to allow external programming of the internal microprocessor 16. A flexible rubber antenna 17 extends from the upper surface of the device housing 18.

As best shown in FIG. 3, a representative monitoring device and RF transmitter 10 is attached to the detector wire 8 of each hose length 6 and is permanently energised by an alkaline or lithium battery cell 20. The life of these cells is limited by the amount of current drained and electronic circuitry within the detector device 10 minimises this current drain to a point where the drain is almost the same as the natural depreciation of the cell in an open circuit or shelf situation. This is controlled by power controller 21.

This very small current drain is constant while-ever the detector device 10 is in operation, however, if there is a break or open circuit in the detector wire 8, the power controller 21, energised by the battery cell, will activate a micro-processor 16 resulting in transmission of a coded signal to a modulator 22 and then through to the transmitter amplifier 23 which as an important aspect radiates the coded RF signal via the antenna 17. The coded signal carries information as to the hose section and type of fault.

The RF signal transmitted is received by an RF receiver 25 and antenna 26 situated in the control room and monitored by an operator. This receiver 25 passes the coded signal to a micro-processor 27 which sounds an audible alarm 28 and/or activates a light emitting diode 29, as well as a display on a liquid crystal display unit 30. The coded signal displayed identifies alarm information such as the hose section by number and its location relative to the beginning of the hose run as well as type of fault. Connected to the micro-processor 27 is also an V/O socket 31 which enables connection to a personal computer (not shown) to allow the storing of the alarm information.

Should an alarm occur, the micro-processor 27 will store the information. The alarm can be turned off by a mute button 32, however, the alarm information can be recalled at any time by the operator and the microprocessor 27 also maintains a history of the hose wearing characteristics.

Although the invention has been described with reference to a specific example shown in the drawings discussed, it will be appreciated by those skilled in the art, that the invention may be embodied in many other forms.

### Further Discussion of the Invention

As can be understood from the discussion of the drawings above, according to one important aspect, the present invention provides a monitoring system for hoses or pipes including, in combination:

a hose with means within the hose wall for providing an electrically conductive path, the conductive characteristics of said path being related to the integrity of said hose wall;

detection means for detecting a change in the conductive characteristics of said conductive path so as to indicate a change in the integrity of said hose wall; and

communication means coupled to said detection means for providing a signal representative of the change in conductive characteristic.

As used in the present specification, the terms “hose” or “hoses” are to be respectively construed as including “pipe” or “pipes” and similar flexible conveying devices within their scope. Further, in the present specification it is to be understood that an object may fall within the scope of the term “hose” regardless of whether said object is straight or includes one or more bends and/or flanges.

Preferably, the signal used in this invention is further representative of the location of the detection device detecting said change in conductive characteristic.

Preferably, the means providing the electrically conductive path is a conductive wire or wires. For preference, the wire is spirally wound within the wall of the hose or fitted to the lining material or flange material of the hose. Typically, a number of detection devices and associated communication means are provided along the length of a hose or pipe.

Preferably, the change in conductive characteristic of the path is the result of the breakage of the conductive path.

For preference, the signal is transmitted to a central monitoring station. Most importantly, the signal is transmitted using a coded radio frequency (RF) signal, a portion of the code being indicative of the location of the detection device. Using radio signals provides advantages in that less failures can occur because of the quick obtaining of most current information.

In one preferred form, the monitoring system includes an electronically controlled device which is connected to an electrically conductive wire, typically copper, in the wall of a rubber lined mining or dredging hose. When the inner lining of the hose wears to such a degree as to wear through this electrical wire conductor, the electronic device is triggered, setting off a coded radio frequency transmitted signal to a base station which, via a coded receiving device and with a visual liquid crystal display, identifies the source of the signal.

This signal is then monitored by the mining or dredging operator to advise the operator that wear has taken place and that there is an estimated life expectancy before the hose fails completely.

In one preferred form, the invention can also be used as an early warning device as well as extending the life of the hose by an early indication which allows the operators to rotate the hose and move the wear point to another location within the hose, thus extending the life of that hose section.

This advantage can be achieved by the insertion of the detector wires in the inner rubber lining of the hose at different depths. Each of these wires can be separately monitored and as the first wire is broken, an alarm is given. The operator will then know to what extent the tube has worn and take appropriate action, either by rotation of the hose or its complete removal, depending on the circumstances

The detector device is described for use with mining and dredge hoses but could also be incorporated in a variety of other hoses, such as oil and fuel pipelines. In such applications the system signals an operator controlled base station, that the hose length has worn through and reached the end of its effective life and may also indicate damage, including cuts or ruptures that have occurred and that the hose then requires immediate action. The number of detectors depends on the number of hose lengths in the hose run.

The detector cable is preferably an electrical conductor embedded in the hose wall in a spiral manner and is placed at a depth corresponding to the end of the useful life of the hose at which the point a warning to the operator is required. A mesh or conductive layer having a predetermined resistance characteristics may also be used.

Preferably, the detector cable is an electrical conductor which is spirally wound into the wall of the hose at the time of manufacture and is of a type selected to be robust enough to withstand the impacts during transport, commissioning and use, however, must easily be worn through when exposed to abrasive slurry or material being pumped through the hose, which occurs when the inside hose wall is worn away.

For preference, the detector includes a radio frequency transmitter connected to the conductor which is activated when the hose has failed and the conductor broken and then transmits a fault signal to the receiver in the control room. The receiver control box at the base station signals the hose failure and identifies the hose length involved when any one of the detectors in the field transmits the fault signal code.

A further preferred embodiment of the system includes the provision of two or more conductors inserted at two or more depths in the hose wall. Failure of the shallowest conductor indicates to the operator that the hose should be rotated, which then will allow an extension of the life of the hose In some applications, up to four rotations in this manner may be possible, effectively providing four times the current life of a hose.

When the deepest detector conductor has worn through, this will signal the end of the useable life and the hose then can be removed and replaced without fear of hose burst.

For preference, the detector conductor terminates in electrical terminals or plugs which are accessible from the outside of the hose, in a position close to either of hose connection flanges. These plugs or terminals are designed to connect to the detector control box, which is securely mounted on one of the flanges or at a convenient rigid structure close by.

A single detector may be used to service each pair of adjacent hoses which halves the number of detectors required in the field, thus reducing cost and chance of damage to the detectors.

Another embodiment of the detector is its ability to be in a ‘sleep’ mode to minimise the drain of current on the battery mounted within the detector, and is only activated when the detector conductor is broken thus extending the life of the battery cell considerably.

In one embodiment, the receiver control box consists of a RF receiver and display unit with three electronic functions to receive the failed signal from any of the detectors currently in the field and generate an audible and visual alarm, determined by decoding the RF signal as to which transmitter has sent the signal, and display on an LCD display the identity and location of the failed hose.

Preferably, the receiver control box is constantly monitoring the designated RF frequency for failure and is permanently connected to a 240 volt 50 cycle power source with a battery backup and may typically receive signals from approximately 1km distance. The RF signal carried is preferably digitally coded to enable unique identification of the hose and the wear condition of the hose.

The receiver control box may utilise internal logic circuits including a micro-processor with a look-up capability to correlate the signal code with the hose number and location, and is programmed into the unit at the time each detector is installed in the field. The code and descriptions can be changed on site at any time by connecting a PC or laptop to the control box and entering the appropriate information.

On receiving the failed signal, the receiver control box as described above preferably generates the audible and/or visual alarm to alert the operator on duty. In a preferred embodiment the display indicates the identification number of the hose length and the field location which the operator is required to investigate.

In another preferred arrangement, an on site personal computer control system may be connected to the control box so that the alarm and failure information may be incorporated into the normal plant operating systems with information such as installation dates, expected failure dates also being stored and displayed. This would give the operator an indication as to whether the failure has occurred as a result of normal wear or through catastrophic failure. In addition, such information as the number of times the hose has been rotated, could also be stored and displayed.

According to another aspect of the invention there is provided a method of hose management using a monitoring system as described above, including the steps of:

i) receiving a signal from said communication means;

ii) analysing said signal to determine the location of the detection means coupled to the communication means from which the signal emanated;

iii) rotating sections of the hose to move a wear point to another location within the hose, thus extending the life of that hose section

The method preferably further includes the steps of:

separately monitoring each of the conductive means as disposed at various depths within the hose wall;

as a conductive means is broken, a signal is transmitted by the communication means including information indicative of which of the conductive means has caused the signal;

analysing said signal to determine the extent to which the tube has worn and;

taking appropriate action on the basis of said analysis, including either rotating sections of the hose or completely removing sections of the hose, depending on the circumstances.

More preferably, this method includes the steps of:

disposing two or more conductive means inserted at various depths in the hose wall;

receiving a signal indicating that the shallowest conductor has failed and then rotating sections of the hose.

For preference each section of the hose may be rotated up to four times, effectively providing four times the current life of a hose.

In the preferred method, upon receiving a signal indicative that the deepest detector conductor has worn through, the operator determines that the section of the hose has come to the end of its useable life and therefore that section is removed and replaced.

Another optional refinement of the method of the present invention involves storing expected failure dates within an on-site personal computer control system, and:

upon receiving a signal indicative that a section of hose has failed, retrieving information from the on-site personal computer control system indicative of an expected failure date of said section of hose; and

comparing said expected failure date to the current date to obtain an indication as to whether the failure has occurred as a result of normal wear or through catastrophic failure.

What we claim:

1. A monitoring system for hoses or pipes including, in combination:
a hose or pipe containing means within the wall thereof providing an electrically conductive path, the conductive characteristics of said path being related to the integrity of said hose or pipe wall;
detection means for detecting a change in the conductive characteristics of said conductive path so as to indicate a change in the integrity of said or pipe hose wall; and
communication means coupled to said detection means for providing a signal representative of the change in conductive characteristics.

2. A monitoring system according to claim 1 wherein said signal is further representative of the location of the detection device detecting said change in conductive characteristic.

3. A monitoring system according to claim 1 wherein said signal is transmitted to a central monitoring station.

4. A monitoring system according to claim 1 wherein a plurality of means for providing an electrically conductive paths, detection devices and associated communication means are provided along the length of the hose or pipe.

5. A monitoring system according to claim 1 wherein the signal is transmitted using a coded radio frequency (RF) signal, a portion of the code being indicative of the location of the detection device.

6. A monitoring system according to claim 1 wherein the means providing the electrically conductive path is a conductive wire or wires.

7. A monitoring system according to claim 6 wherein the wire is spirally wound within the wall of the hose or pipe or fitted to the lining material or flange material of the hose or pipe.

8. A monitoring system according to claim 6 wherein the wire is placed at a depth corresponding to the end of the useful life of the hose or pipe, at which the point a warning to a operator is required.

9. A monitoring system according to claim 1 wherein the change in conductive characteristics of the path is the result of the breakage of the conductive path.

10. A monitoring system according to claim 1 wherein more than one means for providing an electrically conductive path are disposed within the hose or pipe wall at different depths, each of said means being separately monitorable.

11. A monitoring system according to claim 1 wherein said means for providing an electrically conductive path is provided by a mesh or conductive layer having a predetermined resistance characteristics.

12. A monitoring system according to claim 1 wherein the means for providing an electrically conductive path is embedded within the hose or pipe wall during manufacture of the hose or pipe wall.

13. A monitoring system according to claim 1 wherein the communication means is provided by a radio frequency transmitter connected to the conductor which is activated when the hose or pipe has failed and the conductor broken and then transmits a fault signal to a receiver in a control room.

14. A monitoring system according to claim 13 wherein the receiver signals the hose failure and identifies the hose length involved when any one of the detectors in the field transmits a fault signal code.

15. A monitoring system according to claim 1 wherein the means for providing an electrically conductive path terminates in electrical terminals or plugs which are accessible from the outside of the hose and are connectable to the detector means.

16. A monitoring system according to claim 15 wherein said terminals or plugs are disposed close to a hose connection flange.

17. A monitoring system according to claim 16 wherein detector means is mounted on one of the flanges.

18. A monitoring system according to claim 1 wherein each detector means is in communication with the conductors disposed within each pair of adjacent hoses, thereby halving the number of detectors required in the field.

19. A monitoring system according to claim 1 wherein the detector has a ‘sleep’ mode to minimise the drain of current on a battery mounted within the detector, whereby said detector is adapted to toggle between said ‘sleep’ mode, and an ‘active’ mode as required when the conductor is broken, thereby extending the life of the battery.

20. A monitoring system according to claim 13 wherein the receiver includes:
an RF receiver to receive the signal from any of the detectors in the field;
a de-coder to de-code the RF signal so as to determine which transmitter has sent the signal; and
a display unit to generate an audible and/or visual alarm.

21. A monitoring system according to claim 20 wherein said visual alarm includes an LCD display adapted to display information indicative of the identity and location of the failed hose which transmitter has sent the signal, as determined by the de-coder.

22. A monitoring system according to claim 20 wherein the receiver constantly monitors the designated RF frequency for failure.

23. A monitoring system according to claim 22 wherein said receiver is permanently connected to a 240 volt 50 cycle power source with a battery backup.

24. A monitoring system according to claim 22 wherein said receiver is adapted to receive signals from up to approximately 1km distance.

25. A monitoring system according to claim 20 wherein the receiver utilises internal logic circuits including a micro-processor with a look-up capability to correlate the signal code with the hose number and location.

26. A monitoring system according to claim 25 wherein said look-up capability is programmed into the unit substantially at the time each detector is installed in the field.

27. A monitoring system according to claim 25 wherein the code and descriptions can be changed on site at any time by connecting a PC or laptop to the control box and entering the appropriate information.

28. A monitoring system according to claim 1 further including an on-site personal computer control system connectable to the receiver so that alarm and failure information may be incorporated into the normal plant operating systems.

29. A monitoring system according to claim 28 wherein said on-site personal computer control system is further adapted to store and display installation dates, expected failure dates and the number of times each section of the hose has been rotated.

30. A monitoring system according to claim 1 wherein the signal is digitally coded to enable unique identification of the hose and the wear condition of the hose.

31. A business method of hose or pipe management using a monitoring system, including the steps of:
i) receiving a signal from a communication means connected to a detection means;
ii) analysing said signal to determine the location of the detection means coupled to the communication means from which the signal emanated; and
iii) rotating all or sections of the hose or pipe to move a wear point to another location within the hose, thereby extending the life of the hose or pipe.

32. A method according to claim 31 wherein the monitoring system, further including the steps of:
separately monitoring each of the conductive means;
as a conductive means is broken, a signal is transmitted by the communication means including information indicative of which of the conductive means has caused the signal;
analysing said signal to determine the extent to which the tube has worn and;
taking appropriate action on the basis of said analysis, including either rotating sections of the hose or completely removing sections of the hose, depending on the circumstances.

33. A method according to claim 32 including the steps of:
disposing two or more conductive means inserted at various depths in the hose wall;
receiving a signal indicating that the shallowest conductor has failed and then rotating sections of the hose

34. A method according to claim 33 wherein each section of the hose is rotated up to four times, effectively providing four times the current life of a hose.

35. A method according to claim 33 wherein, upon receiving a signal indicative that the deepest detector conductor has worn through, determining that the section of the hose has come to the end of the useable life and therefore removing and replacing that section of the hose.

36. A method according to claim 31 wherein the monitoring system, further including the steps of:
upon receiving a signal indicative that a section of hose has failed, retrieving information from the on-site personal computer control system indicative of an expected failure date of said section of hose; and
comparing said expected failure date to the current date to obtain an indication as to whether the failure has occurred as a result of normal wear or through catastrophic failure.
